(19) United States
(12) Patent Application Publication
(10) Pub. No.: US 2004/0212612 A1
(43) Pub. Date: Oct. 28, 2004

(54) METHOD AND APPARATUS FOR CONVERTING TWO-DIMENSIONAL IMAGES INTO THREE-DIMENSIONAL IMAGES

(76) Inventors: Michael Epstein, West Palm Beach, FL (US); Nathan Newman, West Palm Beach, FL (US); Joseph Krahn, Chapel Hill, NC (US)

Correspondence Address: MALIN HALEY AND DIMAGGIO, PA, 1936 S ANDREWS AVENUE, FORT LAUDERDALE, FL, 33316, US

(21) Appl. No.: 10/709,290

(22) Filed: Apr. 27, 2004

Related U.S. Application Data
(60) Provisional application No. 60/465,791, filed on Apr. 28, 2003.

(51) Int. Cl. G06T 15/00

(52) U.S. Cl. 345/419

(57) ABSTRACT

A method and apparatus for producing stereoscopic 3-D images for monoscopic 3-D data including an automated method and apparatus for converting input monoscopic 3-D graphical data to stereoscopic 3-D images. The method includes extrapolating a left stereo image and a right stereo image to minimize distortion in the final 3-D stereoscopic image which is independent of the video display hardware used for viewing the images and thus can be used with various display systems without modification. The method and apparatus may also be used with or without glasses (using an auto-stereoscopic display) for providing realistic 3-D images.

### BACKGROUND OF INVENTION

Field of the Invention

The present invention relates to a method and apparatus for producing stereoscopic 3-D images from monoscopic 3-D data and specifically to an automated method and apparatus for converting input monoscopic 3-D graphical data to stereoscopic 3-D images.

Stereoscopic image systems are widely used in the entertainment business and research applications to provide video displays in which viewers can view objects in three dimensional space with realistic depth perception. Generally, stereoscopic image display systems display image pairs to the eyes of a viewer. These image pairs correspond to left and right views as seen by the left and right eye of the viewer. When viewed together, these image pairs cause the viewer to perceive a stereoscopic image.

Virtual stereoscopic images may be produced from images formed by a computer-based 3-D modeling system. These systems are especially useful for viewing stereoscopic virtual 3-D images, such as those produced by video-gaming applications. Such images are produced by specifying parameters for two camera views of the image, one corresponding to a left view and one corresponding to a right view. Typically, the camera parameters used to produce these left and right views correspond to a left and right eye view as seen by a viewer of the image. The left eye views are then fed to the left eye of the viewer and the right eye views are fed to the right eye of the viewer such that the viewer sees a 3-D stereoscopic view of the image.

Prior art stereoscopic display systems, however, often select left and right stereo image views that do not adequately correspond to a viewer”s left and right eyes, thus causing eye fatigue and resulting in a less realistic looking stereoscopic image. Furthermore, in order to produce stereoscopic images for applications such as video-gaming, it is necessary for a stereoscopic display system to automatically produce stereoscopic images from a continuous stream of 3-D graphical data. One problem with automating this process, however, is eliminating image distortion associated with differing application and video frame rates.

Conventional stereoscopic display methods and apparatus are also hardware dependent in that they are designed to work with specific video display systems, by using hardware drivers designed to display images through specific video cards. For example, a conventional stereoscopic display method may work on a nVidia brand video card but not on a ATI brand video card. Furthermore, even within the nVidia cards the model GeForce 3 would work, but if a GeForce 3A was released then the driver must be modified in order for the stereoscopic display method to work with that particular card.

Thus, there is a need in the art for a hardware independent method and apparatus for automatically converting a stream of 3-D monoscopic images into distortion-free 3-D stereoscopic images.

### SUMMARY OF INVENTION

An exemplary embodiment of the present invention includes an automated method of converting monoscopic 3-D graphical data into stereoscopic 3-D images. The invention is particularly useful for viewing 3-D video game images as stereoscopic 3-D images. The method includes inputting 3-D graphical data, extrapolating a left stereo image and a right stereo image from said 3-D graphical data, and combining said left and right stereo images to produce a stereoscopic image. The method includes extrapolating a left stereo image and a right stereo image so as to minimize distortion in the final 3-D stereoscopic image. Furthermore, the method of converting monoscopic 3-D graphical data in stereoscopic 3-D images of the present invention is independent of the video display hardware used for viewing the images, and thus may be used with various display systems without modification.

An exemplary embodiment of the present invention also includes an apparatus for converting monoscopic 3-D graphical data into stereoscopic 3-D images. The apparatus includes an inputting means, for inputting monoscopic 3-D graphical data, an analyzing means, for analyzing said 3-D graphical data for the presence of perspective, an extrapolating means, for extrapolating left and right stereo images, and a hardware independent stereoscopic image viewing means, for viewing said left and right stereo images as a single stereoscopic image. The apparatus further comprises an image extracting adjustment means, for adjusting the left and right stereo image extracting parameters.

These and other features and advantages of the invention will be better understood from the following detailed description, which is provided in connection with the accompanying drawings.

### BRIEF DESCRIPTION OF DRAWINGS

FIG. 1. is a block diagram showing the method of converting monoscopic images into stereoscopic images according to the present invention;

FIG. 2. is a block diagram showing the method of extracting a left stereo image and a right stereo image from inputted monoscopic 3-D graphical data;

FIG. 3. is a block diagram showing the method of minimizing distortion of the stereoscopic image formed when a left stereo image and a right stereo image are combined; and

FIG. 4. is a diagram showing the configuration of an apparatus for converting monoscopic images into stereoscopic images according to the present invention.

### DETAILED DESCRIPTION

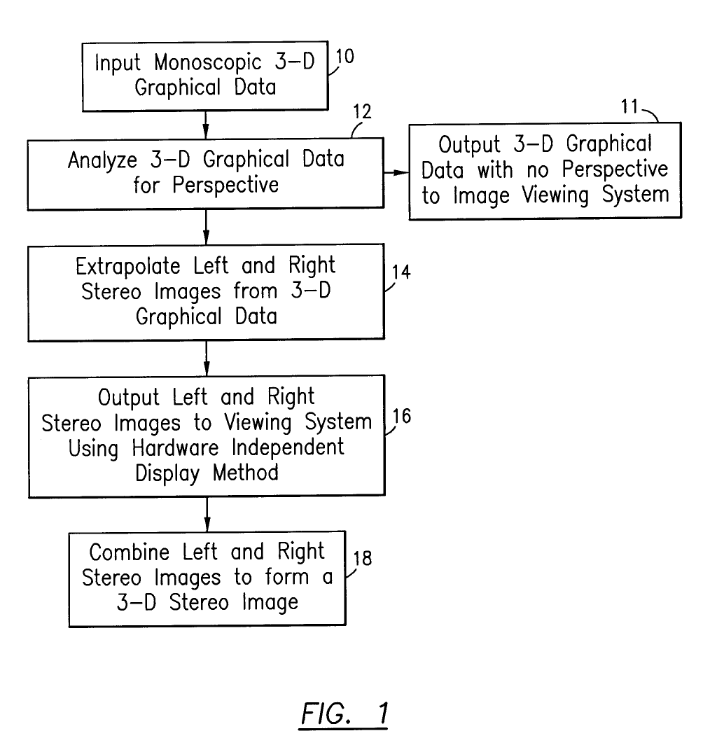

FIG. 1. illustrates an exemplary method of the present invention by which monoscopic images are converted into stereoscopic images. Generally, the method comprises the steps of inputting monoscopic three-dimensional (3-D) graphical data, block 10, analyzing said monoscopic 3-D graphical data for the presence of perspective, block 12, extrapolating a left stereo image and a right stereo image from said monoscopic 3-D graphical data containing perspective, block 14, outputting said left and right stereo images to an image display system via a hardware independent display method, block 16, and combining said left stereo view and said right stereo view to produce a 3-D stereoscopic image, block 18.

First, at block 10, monoscopic 3-D graphics data is inputted, for example, by a 3-D computer graphics program. A software application can generate the incoming 3-D graphics data stream by passing x, y, and z coordinates to a computer graphics rendering program such as OpenGL. OpenGL is a low-level graphics library specification that makes available to a programmer a set of geometric primitives (e.g. points, lines, polygons, images, bitmaps). OpenGL provides a set of commands that allow the programmer to specify geometric objects in two or three dimensions by using the provided primitives together with commands that control how these objects are rendered into the frame buffer. While the exemplary embodiments of the present invention is not so limited, conversion of monoscopic images into stereoscopic images in accordance with the present invention can be achieved using any graphics rendering system that uses linear transformation or a projection viewing matrix, such as DirectX.

In the second step of the first exemplary embodiment described above and shown at block 12, each set of 3-D graphical data representing a distinct scene is analyzed for the presence of perspective, indicating that the scene is intended to be viewed in 3-D. Normally, an application rendering the 3-D data stream sets the projection matrix, then switches the matrix mode to model view. When the matrix is switched out of projection mode, the current projection matrix is read and analyzed. If no perspective is found, it is assumed that the projection matrix is a projection for 2-D rendering that is not part of the 3-D scene (e.g. status messages) and the matrix is not modified and is outputted to the image viewing system described below.

Block 14 shows a third step of the first exemplary embodiment described above in which the inputted monoscopic 3-D graphics stream is modified to produce a left stereoscopic image and a right stereoscopic image. Conventionally, a 3-D graphics stream produced by a 3-D computer graphics program, as described above, is rendered to a 2-D display system for viewing. According to the present invention, however, the inputted 3-D graphics stream is first modified into a left stereo image and a right stereo image, before being outputted to a display system for viewing. The present invention creates these left and right stereo images by selecting two separate camera views of the inputted 3-D graphics stream, one corresponding to a view as seen by the left eye of a viewer, the other corresponding to a view as seen by the right eye of a viewer. The left and right camera views are selected as described below.

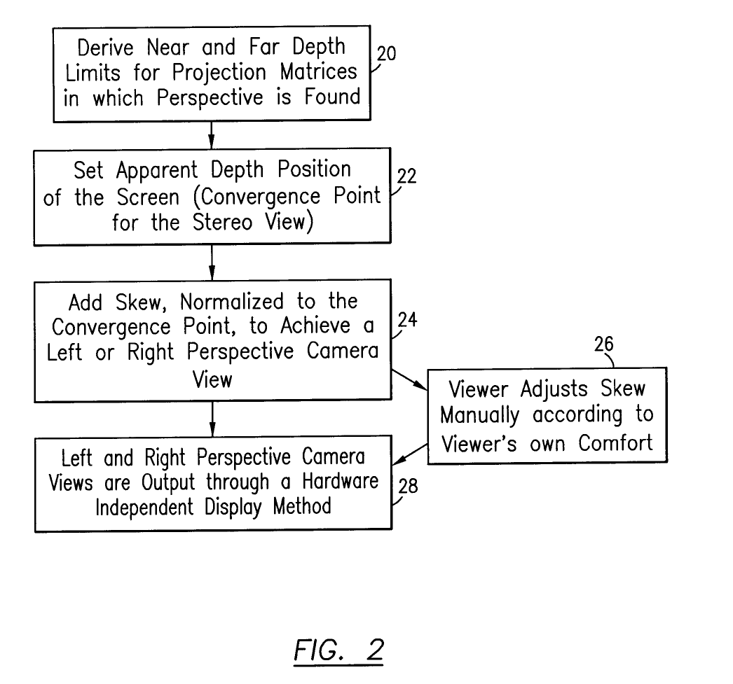

FIG. 2 represents the method of determining the parameters from which left and right stereo images are extracted and output as shown in blocks 14 and 16 of FIG. 1. While the following description may refer to creation of a left stereo image first and a right stereo image second, in accordance with the present invention, either the left or right stereoscopic viewpoint can be generated first. First, at block 20, near and far depth limits are derived for linear transformation or projection matrices in which perspective is found. Next, at block 22, the apparent depth position of the screen (convergence point for the stereo view) is set as a fractional position between the near and far values, typically very close to the near Z coordinate (with a few objects appearing in the front of the screen) 22. As shown at block 24, a skew is then added dynamically, normalized to the convergence point, to achieve either a left or right camera view 24. The skew, for example, can be initially set as the sine of the angle between the monoscopic view and the offset of one eye. The present invention, however, allows a viewer to manually adjust the skew according to the viewer”s own comfort, as shown at block 26.

The left and right stereo images are then outputted to an image display system via a hardware independent display method, block 28. For example, the extrapolated left and right stereo images do not require hardware specific software drivers to display the images through the video card of a display system, as described below. The exemplary method described here bypasses this requirement by attaching its output to the openGL, directX, or similar rendering application being used. Since those applications already have a direct output stream (i.e. they can be read by any display system), no additional software driver is necessary in order for the video display system to display the images. Thus, because left and right stereo images outputted to a video display system according to the present invention are independent of the hardware used in the video display system, they can be displayed using any type of video card and need not be updated as each new video card model is released.

In accordance with the present invention, the left and right stereo images created at block 14 in FIG. 1 are both created and outputted for viewing sequentially. For example, a left image of a given input scene is extracted first and outputted to the viewers left eye and as described below, followed by a right image of the same scene. Scenes in the form of monoscopic 3-D graphical data are continually inputted and automatically converted to left and right stereoscopic images for viewing as a stereoscopic image as described. Thus, the steps in the method outlined in FIG. 1 repeat until the 3-D graphical data input is terminated.

In another exemplary embodiment of the present invention, left and right stereo viewpoints are created sequentially from the incoming 3-D data stream, as described above, while allowing the application to redraw between creation of the left and right stereo views. According to this exemplary method of creating the left and right stereo views, the application frame rate must match the video frame rate (typically 120 frames/sec.) in order to avoid producing a final stereoscopic image that is distorted due to the time difference between each view.

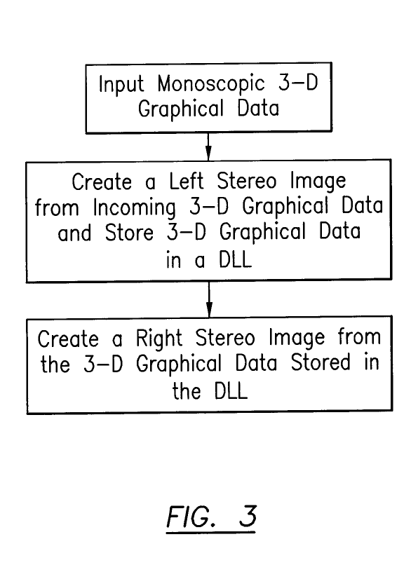

In yet another exemplary embodiment of the present invention, distortion of the final stereoscopic image is minimized by creating sequential left and right stereo images as described above, while storing a set of rendering commands for a given inputted scene in a DLL memory as shown in FIG. 3. In step 1, block 30, monoscopic 3-D data representing a particular scene is inputted. Next, block 32, a left stereo image is created from the incoming 3-D data, which is stored in a DLL memory, block 32. A right stereo viewpoint can then be created from the same stored 3-D data, as shown as block 34. Since both left and right stereo viewpoints are created from the same 3-D data, distortion resulting from disparate application and video frame rates is eliminated.

In a fourth step of the first exemplary embodiment of the present invention described above and shown in block 16 of FIG. 1, the left and right stereo images are combined to produce a stereoscopic image. For example, left and right stereo images are sequentially outputted to a viewing system described below.

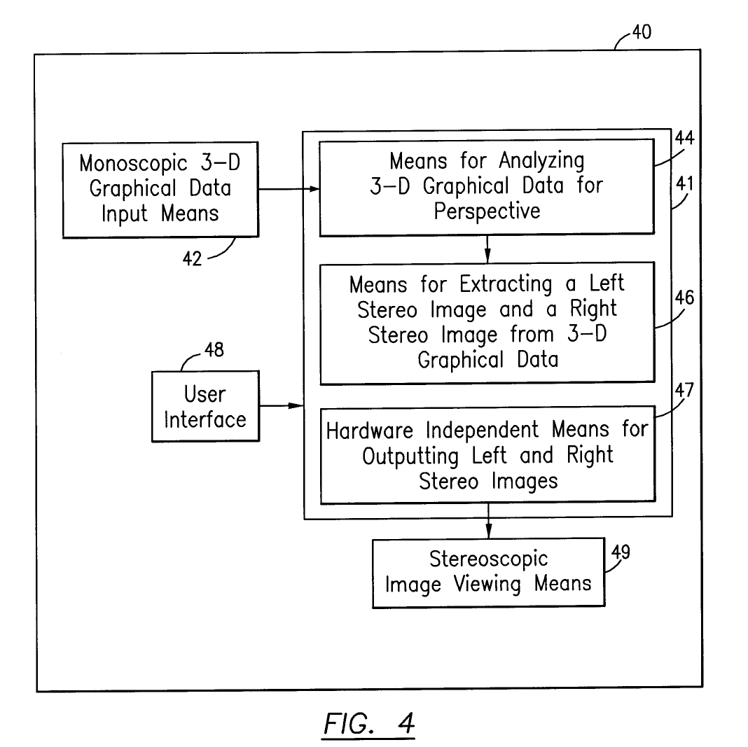

Referring now to FIG. 4, an apparatus for converting 3-D monoscopic images into stereoscopic images 40 comprises a host computer 41, coupled to a monoscopic 3-D data inputting means 42, a means for analyzing said inputted monoscopic 3-D data for the presence of perspective 44, a means for extrapolating a left stereoscopic image and a right stereoscopic images 46 from said monoscopic 3-D data having perspective, a hardware independent means for outputting the left and right stereoscopic images to a video display system 47, a user interface 48, and a means for viewing the left and right stereoscopic images such that they are perceived by the viewer as a 3-D stereoscopic image 49.

The host computer 41 may be a typical desktop PC and includes a CPU, memory, and device drivers (not shown) required to interact with the coupled devices. The monoscopic 3-D data inputting means 42 may be any computer graphics rendering system that uses linear transformation or a projection viewing matrix. One example of such a system is any computer software application that produces 3-D graphical information for viewing by passing 3-D coordinates to the OpenGL library as described above. The perspective analyzing means 44, the left and right image extrapolating means 46, and the hardware independent means for outputting the left and right stereoscopic images to a video display system 47 are devices created by commands executed by the host computer according to the present invention as described above. The user interface 48, may be a keyboard, mouse, or any other type of user interface used in association with computer graphics.

In accordance with the second exemplary embodiment of the present invention, the means for extrapolating a left stereoscopic image and a right stereoscopic image 46 includes a means for taking a left camera view and a right camera view of a scene generated by the input monoscopic 3-D data from said data inputting means. As described above, the left and right stereoscopic images are derived by first deriving near and far depth limits for a given image and then setting the apparent depth position of the screen (convergence point for the stereo view) to a fractional position between the near and far values, typically very close to the near Z coordinate (with few objects appearing in front of the screen). A skew is then added normalized to the convergence point, to achieve either a left or right camera view. The skew, for example, can be initially set as the sine of the angle between the monoscopic view and the offset of one eye. The present invention, however, allows a viewer to manually adjust the skew according to the viewers own comfort via the user interface 48.

The means for viewing 49 the left and right stereoscopic images such that they are perceived by the viewer as a 3-D stereoscopic image may comprise a video card and video monitor and 3-D viewing glasses or by auto-stereoscopic displays (glasses-free), all of which are well known in the art. Using auto-stereoscopic displays, the user would not need glasses to filter the left eye view and the right eye view. The monitor screen would perform the filtering actions, although the viewing method is the same sending one view to each eye. Exemplary video cards include, but are not limited to, nVidia and ATI brand cards. Exemplary monitors include any monitor capable of displaying images from 3-D graphical data. Exemplary 3-D glasses include eDimensional”s E-D glasses, which are worn by the viewer. Essentially, output of the left and right stereo images to the monitor via the video card and the action of the 3-D glasses is synchronized in order to produce a stereoscopic 3-D image. For example, the left stereoscopic image outputted to the monitor is displayed, while the right lens of the 3-D glasses is simultaneously made opaque such that only the viewer”s left eye sees the left stereoscopic image. The step is then repeated for the right stereoscopic image and alternates between left and right at the scan rate of the monitor such that the viewer appears to simultaneously see the left and right stereo images of a given inputted scene and perceives a stereoscopic 3-D image of the scene. Furthermore, the means for outputting the left and right stereo images to the video card is independent of the video card used in the video display system and thus, as described above, may be used with various video display systems without modification.

While exemplary embodiments of the invention have been described and illustrated, various changes and modifications may be made without departing from the spirit or scope of the invention. Accordingly, the invention is not limited by the foregoing description, but it only limited by the scope of the appended claims.

What is claimed is:

1. A method of converting a monoscopic image into a stereoscopic image comprising:
a. Inputting three-dimensional graphical data;
b. Extracting a left stereo image and a right stereo image from said three-dimensional graphical data;
c. Combining said left stereo image and said right stereo image to produce a stereoscopic image.

2. The method of claim 1, further comprising the step of analyzing said three dimensional graphical data for the presence of perspective.

3. The method of claim 1, wherein extracting a left stereo image and a right stereo image comprises:
a. Deriving near and far depth limits for said three-dimensional graphical data;
b. Setting a stereoscopic convergence point between said near and far depth limits;
c. Introducing a skew with respect to said convergence point into said two-dimensional projection matrices such that one two-dimensional projection matrix corresponds to a left-eye view and one two-dimensional projections matrix corresponds to a right eye view.

4. The method of claim 3, wherein said skew is normalized to said convergence point.

5. The method of claim 3, wherein said skew for the left stereo image is the sine of the angle between said left stereo image and the offset of a viewer”s left eye, and said stereo skew for the right stereo image is the sine of the angle between said right stereo image and the offset of a viewer”s right eye.

6. The method of claim 3, wherein said skew is further adjusted according to the comfort of the viewer.

7. The method of claim 1, wherein said steps of extracting a left stereo image and a right stereo image and combining said left stereo image and said right stereo image to produce a stereoscopic image are automated.

8. An apparatus for converting a monoscopic image into a stereoscopic image comprising:
a. Inputting means for inputting 3-D graphical data;
b. Analyzing means for analyzing said 3-D graphical data for the presence of perspective;
c. Extracting means, for extracting a left and right stereo image from said 3-D graphical data; and
d. Stereoscopic viewing means, for viewing said left and right stereo images as a 3-D stereoscopic image.

9. The apparatus of claim 1, wherein said inputting means is a computer applications software.

10. The method of claim 1, wherein said extracting means comprises:
a. a means for deriving near and far depth limits for said three-dimensional graphical data;
b. a means for setting a stereoscopic convergence point between said near and far depth limits; and
c. a means for introducing a skew with respect to said convergence point into said two-dimensional projection matrices such that one two-dimensional projection matrix corresponds to a left-eye view and one two-dimensional projection matrix corresponds to a right eye view.

11. The method of claim 10, wherein said skew for the left stereo image is the sine of the angle between said left stereo image and the offset of a viewers left eye, and said skew for the right stereo image is the sine of the angle between said right stereo image and the offset of a viewers right eye.

12. The method of claim 10, wherein said skew is further adjusted according to the comfort of the viewer.
